(19) United States
(12) Patent Application Publication
(10) Pub. No.: US 2018/0263412 A1
(43) Pub. Date: Sep. 20, 2018

(54) BEVERAGE HEATING SYSTEM

(71) Applicant: Debra Faye Winters, Delaware City, OK (US)

(72) Inventor: Debra Faye Winters, Delaware City, OK (US)

(21) Appl. No.: 15/923,619

(22) Filed: Mar. 16, 2018

Related U.S. Application Data
(60) Provisional application No. 62/472,829, filed on Mar. 17, 2017.

(51) Int. Cl. A47J 36/24; A47J 31/00

(52) U.S. Cl. CPC A47J 36/2483; A47G 19/2288; A47J 36/2461; A47J 31/005

(57) ABSTRACT

A beverage heating system is provided. The beverage heating system includes a container for storing a beverage within an interior volume. A heating element of the container provides thermal energy to the beverage. A docking station engages with the container and provides power to a power supply of the container. The power supply and a thermostat control the amount and intensity of thermal energy provided by the heating elements. In one embodiment, the heating element is one or more heating rings positioned along an interior side of the sidewall at vertical intervals. The thermostat further includes a timer and alarm that are programable to activate the heating element or an indicator.

### CROSS REFERENCE TO RELATED APPLICATION

This application claims the benefit of U.S. Provisional Application No. 62/472,829 filed on Mar. 17, 2017. The above identified patent application is herein incorporated by reference in its entirety to provide continuity of disclosure.

### BACKGROUND OF THE INVENTION

### FIELD OF THE INVENTION

The present invention relates to a beverage heating system. More specifically, the present invention provides a container having heating elements controlled via a thermostat, the power supply of the container being inductively charged by a docking station.

There are many beverages that are preferably consumed at a temperature that is elevated relative to a typical room temperature. For example, coffee and soup are generally heated and subsequently enjoyed by the consumer. However, many individuals wishing to enjoy these foods and beverages lack access to stoves or conventional cooking appliances when hiking, camping, or merely traveling. Transferring heated food and beverages to certain containers will provide only a limited time to enjoy the food or beverage prior to cooling thereof.

Devices have been disclosed in the known art that relate to beverage heating. These include devices that have been patented and published in patent application publications. These devices in the known art have several known drawbacks.

In light of the devices disclosed in the known art, it is submitted that the present invention substantially diverges in design elements from the devices in the known art and consequently it is clear that there is a need in the art for an improvement to existing beverage heating devices. In this regard, the instant invention substantially fulfills these needs.

### SUMMARY OF THE INVENTION

In view of the foregoing disadvantages inherent in the known types of beverage heating devices now present in the art, the present invention provides a new beverage heating system wherein the same can be utilized for providing convenience for the user regulating a temperature of beverage when traveling and access to electrical outlets is not feasible.

It is therefore an object of the present invention to provide a new and improved beverage heating system. The beverage heating system includes a container defining an interior volume that can hold food and beverage contents therein. An insulated sidewall of the container prevents the thermal transfer thereacross and a heating element operably connected to a power supply provides thermal energy to the contents of the container. The heating element is disposed on an interior side of the sidewall at vertical intervals so as to provide even heating thereof. A charging dock sized to receive a portion of the container and inductively supply power thereto via a wireless charger.

Another object of the present invention is to provide a beverage heating system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 there is shown a perspective view of the beverage heating system.

FIG. 2 there is shown a close-up view of the docking station of the beverage heating system.

FIG. 3 there is shown an elevated view of the interior of the beverage heating system.

FIG. 4 there is shown a cross sectional view of the sidewall of the beverage heating system taken along line IV-IV of FIG. 3.

FIG. 5 there is shown block diagram of the beverage heating system.

### DETAILED DESCRIPTION OF THE INVENTION

Reference is made herein to the attached drawings. Like reference numerals are used throughout the drawings to depict like or similar elements of the beverage heating system. For the purposes of presenting a brief and clear description of the present invention, the preferred embodiment will be discussed as used for heating liquids such as coffee, tea, and soup. The figures are intended for representative purposes only and should not be considered to be limiting in any respect.

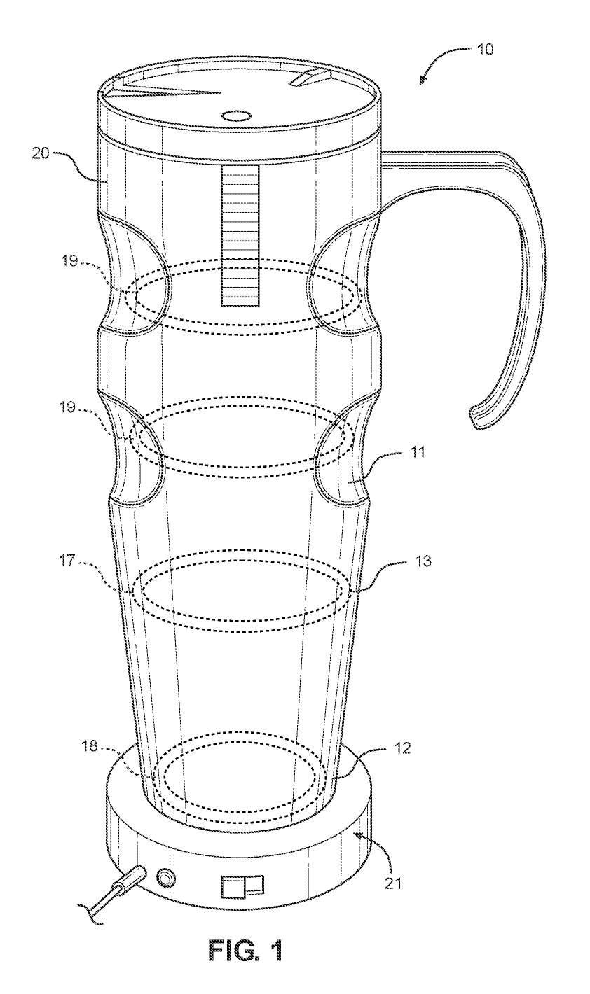

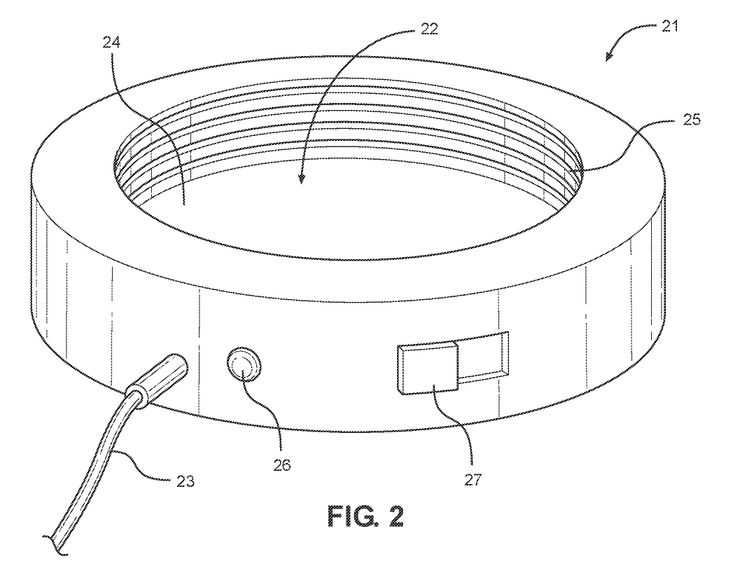

Referring to FIGS. 1 and 2, there is shown a perspective view of the beverage heating system and a close-up view of the docking station of the beverage heating system, respectfully. The beverage heating system 10 provides a vessel adapted to hold or raise the temperature of a liquid stored therein. The beverage heating system 10 comprises a container 11 having a base 12 and an updating sidewall 13 extending upward around a perimeter of the base 12. The base 12 and sidewall 13 form an interior volume configured to hold liquid, such as coffee, tea, and the like. In the shown embodiment, the container 11 is a thermos-cup having an open upper end that removably receives a lid thereover. The container 11 is sized to be received by a docking station 21 at the base end.

The container 11 further includes a heating element 17 configured to provide thermal energy to the contents thereof. In one embodiment, the heating element 17 are heating rings 19 disposed on an interior side of the sidewall. The heating element 17 is electrically connected to the power supply 18, wherein a controller 20 controls the activation, deactivation, and other settings or configurations thereof.

The docking station 21 includes a planar lower end that is adapted to rest on a level surface and secure the container 11 in an upright orientation. The docking station 21 provides a wireless charger that is configured to provide energy to a power supply 18 of the container 11. In the shown embodiment, the power supply 18 is disposed on the base 12 of the container for close proximity to the docking station 21. Referring to FIG. 2, the docking station 21 is a cylindrical disk having a recess 22 disposed centrally and dimensioned to receive the container 11 therein. In the shown embodiment, the recess 22 include a series of concentric grooves 25 that extend upward a tapered interior side of the recess 22. The grooves 25 provide for a more secure connection between the received container 11 and docking station.

The docking station 21 further includes an activation switch 27 that controls an induction charger 24. The induction charger 24 is configured to inductively couple the power supply 18 of the container 11 and to transfer energy thereto via an electromagnetic field created therebetween. A light 26 of the docking station 21 indicates the present state of charging, i.e. active or inactive. A wired connection 23 extends from the docking station 21 to provide for direct electrical connection with an electrical outlet. In this way, docking station 21 may be utilized to charge the power supply of the container 11 while there is convenient access to the electrical outlet. Upon traveling, container 11 is removed from the docking station 21 and selectively controlled via the controller 20, so as to heat the contents to a desired temperature via the heating elements 17.

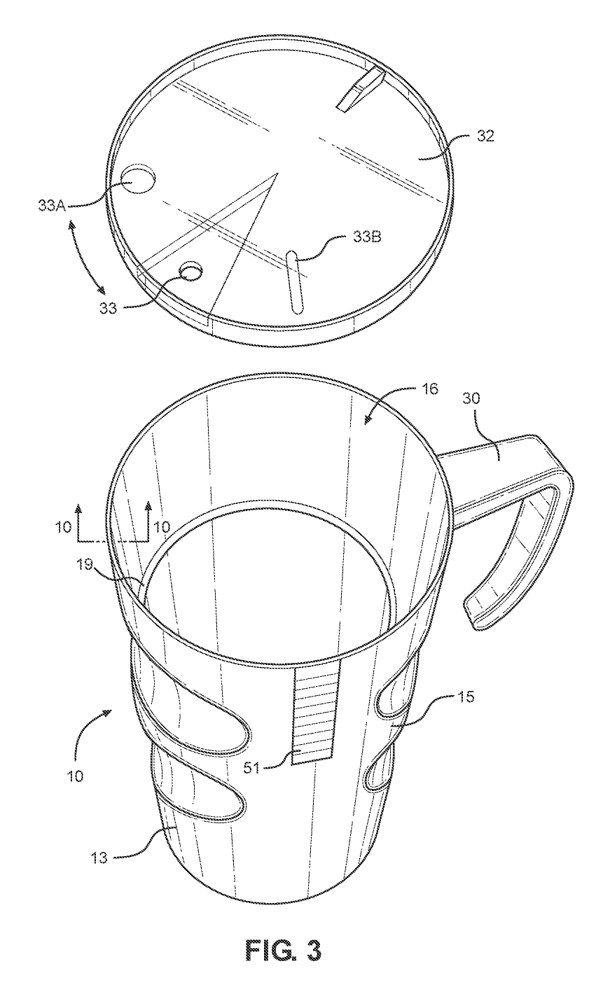

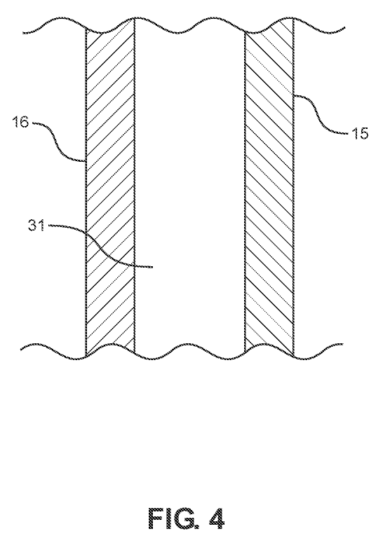

Referring to FIGS. 3 and 4, there is shown an elevated view of the interior of the beverage heating system and a cross-sectional view of the sidewall of the beverage heating system taken along line IV-IV of FIG. 3, respectfully. In the shown embodiment, the heating rings 19 of the container are disposed at vertical intervals extending between the base and the open upper end. The interval spacing of the heating rings 19 allows from an even distribution of heat throughout the interior volume. Additionally, each heating ring 19 may form a closed ring on the interior side 16.

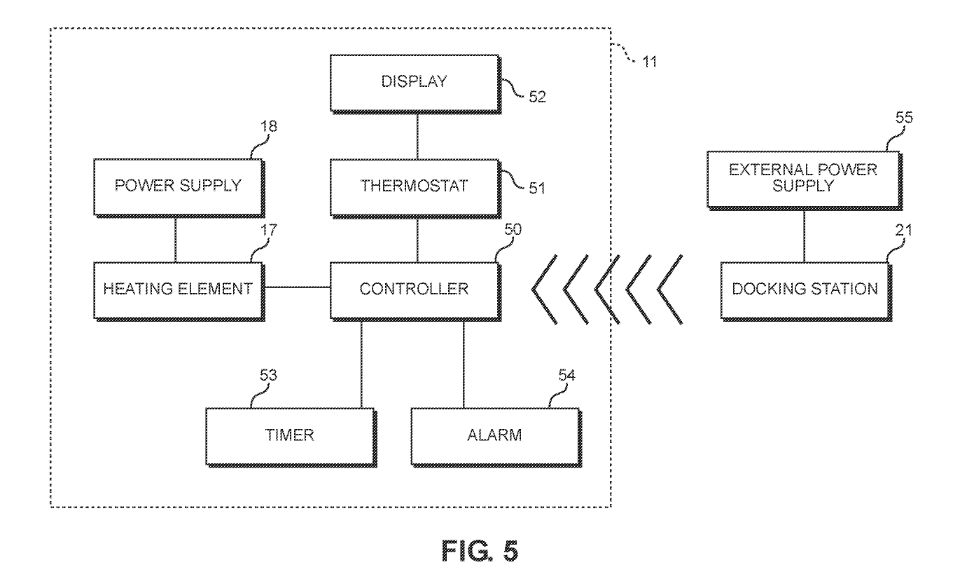

In one embodiment, a thermostat 51 is configured to detect an amount and temperature of the container contents. Further, the thermostat can control the amount of thermal energy being utilized by each heating ring 19. The thermostat 51 includes a display (shown in FIG. 5) on the exterior side 15 that indicates the amount and temperature of the container contents.

As shown in FIG. 3, a lid 32 is dimensioned to removably engage the open upper end of the container. The lid 32 includes several openings 33, 33A, 33B allowing the contents of the container to be dispensed therethrough. The openings 33, 33A, 33B are disposed along a perimeter such that rotation of an upper portion of the lid provides for alignment of the upper and lower portion, and thereby direct access to the contents. In the shown embodiment, a handle 30 extends from the sidewall 13 and allows for manual handling of the container.

The beverage heating system 10 provides for insulation of the contents of the container by having an insulated sidewall 13. The sidewall 13 comprises an insulated interior side 15 and an exterior side 16. In FIG. 4, a void space 31 is disposed between the interior and exterior sides 15, 16 allowing for the presence of a vacuum. The insulated sidewalls 13 and void space prevents the thermal transfer thereacross.

Referring to FIG. 5, there is shown a block diagram of the beverage heating system. The container includes a controller 20 that is operably connected to the components thereof. The thermostat 51 is configured to regulate the heating element 17 and power supply 18 corresponding to a selected desired temperature of the contents. Additionally, the thermostat 51 is further configured to indicate a temperature of the contents on a display 52. A timer 53 is configured to control the heating element 17 after a selected predetermined period of time. An alarm 54 is configured to actuate at least a speaker or light after the selected predetermined period of time has elapsed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A beverage heating system, comprising
a container formed by a base and a sidewall defining an interior volume;
an exterior side of the sidewall composed of insulated material (cross section of sidewall) configured to prevent the thermal transfer thereacross;
a heating element operably connected to a power supply, the heating element configured to provide thermal energy to a content of the container;
wherein the heating element disposed on an interior side of the sidewall.

2) The beverage heating system of claim 1, wherein the heating element includes one or more heating rings disposed at vertical intervals therealong, the intervals being spaced to heat the contents evenly.

3) The beverage heating system of claim 1, wherein each heating ring of the one or more heating rings extend around an entire perimeter of the interior side;

4) The beverage heating system of claim 1, a controller operably connected to the heating element, wherein the controller includes selectively operable controls.

5) The beverage heating system of claim 1, wherein vacuum disposed between the exterior side of the sidewall and an interior side of the sidewall.

6) The beverage heating system of claim 1, wherein the power supply includes a rechargeable battery disposed in the base.

7) The beverage heating system of claim 1, a thermostat configured to regulate the heating element corresponding to a selected desired temperature of the contents.

8) The beverage heating system of claim 1, the thermostat further configured to indicate a temperature of the contents on a display.

9) The beverage heating system of claim 1, a timer configured to control the heating element after a selected predetermined period of time.

10) The beverage heating system of claim 1, an alarm configured to actuate at least a speaker or light after the selected predetermined period of time has elapsed.

11) The beverage heating system of claim 1, the alarm further configured to actuate upon detection by the thermostat of the contents dropping below a temperature threshold.

12) The beverage heating system of claim 1, a charging dock dimensioned to removably receive the base of the container within a recess.

13) The beverage heating system of claim 1, the charging dock including a wireless charger, the wireless charger adapted to inductively couple the power supply of the container and to transfer energy thereto via an electromagnetic field created therebetween.

14) The beverage heating system of claim 1, the charging dock having a wired connection configured to electrically couple to an electrical socket.
